(19) United States
(12) Patent Application Publication
(10) Pub. No.: US 2008/0232385 A1
(43) Pub. Date: Sep. 25, 2008

(54) COMMUNICATION SYSTEM, NODE DEVICE AND METHOD FOR SETTING CLASSES OF SERVICE

(76) Inventors: YOSHIHIKO SUEMURA, Tokyo (JP); Masahiro Sakauchi, Tokyo (JP); Atsushi Iwata, Tokyo (JP)

Correspondence Address: NEC CORPORATION OF AMERICA, 6535 N. STATE HWY 161, IRVING, TX, 75039, US

(21) Appl. No.: 12/053,752

(22) Filed: Mar. 24, 2008

(30) Foreign Application Priority Data
Mar. 23, 2007 (JP) 2007-076906

(51) Int. Cl. H04L 12/56

(52) U.S. Cl. 370/406

(57) ABSTRACT

A communication system comprises a plurality of packet rings, each composed of a plurality of node devices, the node devices each transmitting and receiving a packet and being interconnected in a ring; two of the packet rings being interconnected via a pair of node devices each in each of the packet rings; the communication system further comprising: a table having recorded therein the correspondence between inter-ring service classes set between the packet rings and intra-ring service classes set in each packet ring; wherein the packet transferred in the packet ring includes information on the intra-ring service classes, as intra-ring header information, and information on the inter-ring service class, as inter-ring header information, the inter-ring service class(es) being correlated with the intra-ring service class(es), and being determined based on the table; the intra-ring header information being deleted when the packet is transferred from one of the packet rings to another.

### REFERENCE TO RELATED APPLICATION

This application is based upon and claims the benefit of the priority of Japanese patent application No. 2007-076906, filed on Mar. 23, 2007, the disclosure of which is incorporated herein in its entirety by reference thereto.

### FIELD OF THE INVENTION

This invention relates in particular to a technique for setting the classes of service, used in a packet ring network, such as IEEE802.17 Resilient Packet Ring (RPR).

### BACKGROUND ART

Heretofore, the networks of communication carriers routinely take a multi-ring configuration made up of an interconnection of a plurality of rings. It is the ring based on the Synchronous Digital Hierarchy (SDH) standard that has so far been most widely used in those networks.

The SDH is a time-division multiplexing technique and hence has an advantage that a preset band is guaranteed at all times. However, it suffers from the problem that, should malfunctions occur in a currently used route, detouring must be made to a backup route. Thus, the SDH suffers the problem that a bandwidth twice the inherently needed bandwidth needs to be secured at all times.

Hence, a packet ring technology termed IEEE802.17 Resilient Packet Ring (RPR) has been standardized by IEEE. In RPR, four classes of service are defined. For the classes A0 and A1, the bandwidth is guaranteed, whereas the class C is a best-effort service class for which the bandwidth is not guaranteed. For the class B, two bands, namely the Committed Information Rate (CIR) and the Excess Information Rate (EIR), are defined, and the traffic of EIR may be run off at the maximum, wherein, however, the bandwidth is guaranteed only up to the CIR.

The traffic in excess of the CIR is handled as best effort. The RPR has an advantage that the bandwidth utilization efficiency may be higher than with SDH because there is no necessity with the RPR to provide the backup band at all times.
[Patent Document 1] WO2004/095779
[Patent Document 2] WO2005/027427
[Patent Document 3] JP Patent Kokai Publication No. JP-P2003-229876A

### SUMMARY

The following analyses are given by the present invention.

The entire disclosures of Patent Documents 1, 2 and 3 are incorporated herein by reference thereto.

The RPR, described above, suffers the problem that, if there is a traffic transported through multiple rings, it is not possible to apply consistent service classes throughout the rings. This problem is now described with reference to FIG. 1, showing an example of a general constitution of an optical communication network.

Referring to FIG. 1, a set of traffics, referred to below as a packet flow, delivered to a tributary port 3-a of a node device 1-a in a packet ring 2-A and output at a tributary port 3-j of a node device 1-j in a packet ring 2-B, is now scrutinized.

To each packet, constituting this packet flow, there is appended an RPRMAC header, as an intra-ring header for the node device 1-a. The class of service, applied to this packet flow, is specified at this time in a Service Class (SC) field in the header, based on certain policy.

This packet flow is transmitted via node devices 1-d and 1-e and received by a coupling node device 6-a in the packet ring 2-A, where the RPRMAC header is deleted. The packet flow is then transferred to a coupling node device 6-b in the packet ring 2-B. The coupling node device 6-b appends a new RPRMAC header in order to transfer the packet flow to the node 1-j in the packet ring 2-B.

However, the coupling node device 6-b at this time is unable to distinguish this packet flow from other packet flows, for example, the packet flow transmitted from the node device 1-c through the coupling node device 6-a. The coupling node device 6-b is also unable to comprehend which service class was applied to this packet flow in the packet ring 2-A. Hence, a service class which is not related to that applied to this packet flow in the packet ring 2-A is applied in the packet ring 2-B.

Thus, with the conventional practice, even if, when a packet flow is transferred through multiple packet rings, an input node device of a first packet ring has set a service class of the intra-ring MAC service class, this intra-ring MAC header is deleted at an output node device of the first packet ring. The result is that service classes unrelated to the service class as set in the first packet ring are set in the second and the following packet rings, or the service classes need to be manually set.

In view of the above depicted related art, it is an exemplary object of the present invention to provide a communication system, particularly an optical communication system, a node device and a method for setting the service classes, according to which the service classes may consistently be applied to a packet flow transmitted through respective different packet rings.

According to a first exemplary aspect of the present invention, there is provided a communication system (particularly, an optical communication system) including a plurality of packet rings, each composed of a plurality of node devices. The node devices each transmit and receive a packet, and are interconnected in a ring (preferably, via first bidirectional transmission route). Two of the packet rings are interconnected via a pair of node devices each in each of the packet rings (preferably, by one or more second bidirectional transmission routes; each of the second bidirectional transmission routes may be connected to any one of the node devices of the two packet rings).

The transmission system includes a table having recorded therein the correspondence between inter-ring service classes, as set between the packet rings, and intra-ring service classes, as set in each packet ring. The packets transferred in the packet ring include information on intra-ring service classes, as intra-ring header information, and information on inter-ring service classes, as inter-ring header information. The inter-ring service classes are correlated with the intra-ring service classes, and are determined in advance based on the aforementioned table. The intra-ring header information is deleted when the packet is transferred from one of the packet rings to another. The transmission system comprises a unit for extracting the information on the inter-ring service class contained in the inter-ring header information appended to the packet incoming from another packet ring. The optical transmission system also comprises a unit for determining the intra-ring service class to be set on the incoming packet, by having reference to the aforementioned table, based on the information on the inter-ring service class extracted by the extraction unit, and a unit for appending to the incoming packet the intra-ring header information containing the information on the intra-ring service class as determined by the determining unit.

Thus, according to the present exemplary aspect, an inter-ring header is appended, in addition to the intra-ring header, in an entrance node device of a first packet ring, and a service class is set for this inter-ring header as well. When a packet is transferred from a packet ring to another packet ring, the intra-ring header is deleted, but the inter-ring header is not deleted. That is, the service class is inherited by the inter-ring header, whereby it is possible to set consistent service class(es) throughout the packet rings in their entirety.

According to the second exemplary aspect, the present invention may also be viewed from the perspective of a node device. That is, the present invention provides a node device applied to an optical communication system, and is featured by a unit for extracting the information on the inter-ring service classes contained in the inter-ring header information appended to the packet incoming from another packet ring, a unit for determining the intra-ring service classes to be set on the incoming packet, based on the information on the inter-ring service class extracted by the extraction unit, by having reference to the aforementioned table, and by a unit for appending to the incoming packet the intra-ring header information containing the information on the intra-ring service class as determined by the determining unit.

According to a third exemplary aspect, the present invention may also be viewed from the perspective of an (optical) communication network. That is, the present invention provides an (optical) communication network including the (optical) communication system of the present invention.

According to a fourth exemplary aspect, the present invention may likewise be viewed from the perspective of a method for setting service classes. That is, the present invention provides a method for setting the service classes, carried out by a node device of the present invention. The method comprises: a step of extracting information on the inter-ring service class(es) contained in the inter-ring header information appended to the packet incoming from another packet ring, and a step of determining the intra-ring service class(es) to be set on the incoming packet, based on the information on the inter-ring service class(es) extracted by the extraction step, by having reference to the aforementioned table. The method also comprises a step of appending to the incoming packet the intra-ring header information containing information on the intra-ring service class as determined by the determining step.

According to a fifth exemplary aspect, the present invention may further be viewed from the perspective of a computer readable program that is installed on a information processing apparatus (typically, of general-purpose) to get the functions equivalent to the functions of the node device of the present invention implemented by the (general-purpose) information processing apparatus, or a program that allows for carrying out the sequence of operations equivalent to that of the service class setting method of the present invention.

The meritorious effects of the present invention are summarized as follows.

According to the present invention, a packet ring being transferred through multiple packet rings may have a preset service class applied thereto in any of the packet rings. It is thus possible to carry out packet transfer maintaining the preset service quality even after the packet ring has been transferred through a plurality of packet rings.

### BRIEF DESCRIPTIONS OF THE DRAWINGS

FIG. 1 is a schematic view showing an example of the constitution of a communication network, typically optical.

FIG. 2 is a diagrammatic view showing an RPR packet.

FIG. 3 is a block diagram of a node device.

FIG. 4 is a block diagram of a coupling node device.

FIG. 5 is a block diagram showing an RPRMAC header appending section.

FIG. 6 is a flowchart for illustrating the operation of the RPRMAC header appending section.

FIG. 7 is a diagrammatic view showing an example of a table of correspondence according to a first exemplary embodiment.

FIG. 8 is a diagrammatic view showing an example of a table of correspondence according to a second exemplary embodiment.

FIG. 9 is a schematic view showing an (optical) communication network in a fourth exemplary embodiment of the present invention.

FIG. 10 is a diagrammatic view showing an RPR packet in the fourth exemplary embodiment.

### EXEMPLARY EMBODIMENTS

In the following, exemplary embodiments relating to various aspects of the present invention will be explained.

The table may be configured so that the intra-ring service class will be set depending on whether a packet ring concerned is source or destination of the packet transfer.

Particularly, the table may be configured so that the setting of the intra-ring service class will be higher in a packet ring corresponding to a packet transfer destination than in a packet ring corresponding to a packet transfer source belonging to the same inter-ring service class as that of the packet ring corresponding to the packet transfer destination.

It should be noticed that the more the packet rings through which a packet is transferred, the higher becomes the discarding ratio of the packet. However, with the above table setting, such formulation is possible, wherein the more the packet rings through which a packet is transferred, the higher becomes the service class that is set for the packet. Hence, the packet discarding ratio may be adjusted to a constant value regardless of the length of the transfer route.

Alternatively, the communication system may further comprise a congestion detection unit for detecting whether or not there is a state of congestion in a packet ring which is to be a transfer destination, and a selecting unit that selects a table configured so as to set service class in the packet ring. Preferably, the selecting unit may include a unit for selecting (using) a table configured so that a setting of a service class in a packet ring corresponding to the packet transfer destination will be higher than a setting of a service class in the packet ring corresponding to the packet transfer source, in case the congestion detection unit has detected the state of congestion. Also there is a unit for selecting (using) a table configured so that table contents will be the same in the packet ring corresponding to the source of packet transfer and in the packet ring corresponding to the packet ring destination of packet transfer in case the congestion detection unit has not detected the state of congestion.

In this manner, a higher-ranked service class may be set for a packet ring corresponding to the destination of packet transfer than for a packet ring corresponding to the source of packet transfer in case the state of congestion is detected in the packet ring corresponding to the source of packet transfer. So, it is possible to avert appending a service class which is higher by more than required, thereby improving the bandwidth utilization efficiency.

The communication system may further comprise a unit for appending to the packet, transferred between the packet rings, a plurality of the inter-ring header information, specifying a zone in which the header information may remain valid.

It is thus possible to specify a preset zone and to set a service class valid only within this zone.

As mentioned earlier, the table may also be configured so that the intra-ring service class will be set depending on whether a packet ring concerned is source or destination of the packet transfer. Preferably the setting of the intra-ring service class will be higher in a packet ring corresponding to a packet transfer destination than in a packet ring corresponding to a packet transfer source belonging to the same inter-ring service class as the inter-ring service class of the packet ring corresponding to the packet transfer destination.

The node device, according to the second exemplary aspect, may further comprise a congestion detection unit for detecting whether or not there is a state of congestion in the packet ring which is a destination of transfer, and a unit for using a table configured so that the setting of service class(es) in the packet ring corresponding to the destination of packet transfer will be higher than the setting of service class(es) in the packet ring corresponding to the source of packet transfer in case the congestion detection unit has detected the state of congestion, and for using a table configured so that table contents will be the same in the packet ring corresponding to the source of packet transfer and in the packet ring corresponding to the destination of packet transfer in case the congestion detection unit has not detected the state of congestion. In short, the selection of a table for setting the service class is carried out depending on the congestion in any one of the patent rings.

The node device according to the present invention may further comprise a unit for appending to the packet, transferred between the packet rings, a plurality of the inter-ring header information, by specifying a zone in which the plural header information may remain valid.

A plurality of the inter-ring header information may be appended to the packet, transferred between the packet rings, by specifying a zone in which the plural header information may remain valid.

In the fifth exemplary aspect, on recording the program of the present invention on a recording medium, the information processing apparatus may get the program of the present invention installed on it with the use of the recording medium. Or, the program of the present invention may directly be installed on the information processing apparatus over a network from a server holding the program.

By so doing, it is possible to implement the functions equivalent to those of the node device of the present invention in order to execute the sequence of operations equivalent to that of the service class setting method of the present invention.

It should be noticed that the program of the present invention encompasses not only a program that may directly be executed by the (general-purpose) information processing apparatus, but also a program that may be executed when installed on, e.g., a hard disc, or a compressed or encrypted program.

### First Exemplary Embodiment

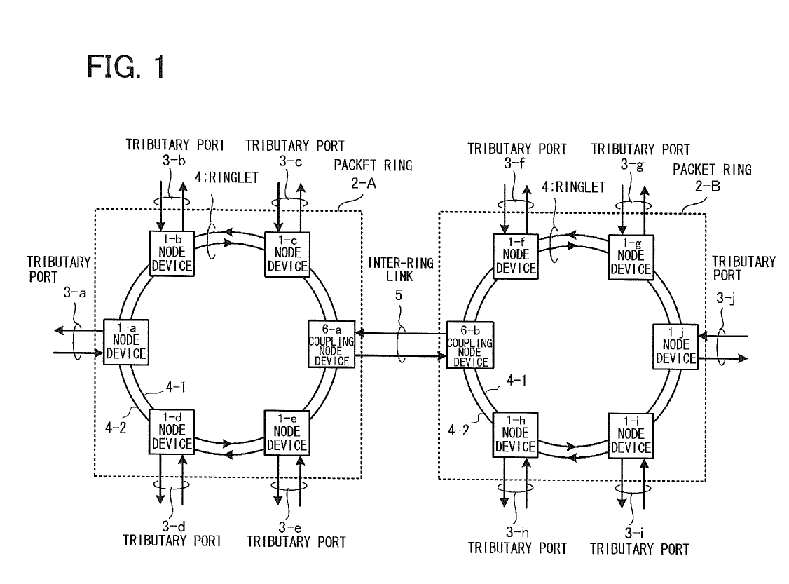

An optical communication network according to a first exemplary embodiment of the present invention is now described with reference to FIGS. 1 to 7. An optical communication network, shown in FIG. 1, is composed of two packet rings 2-A and 2-B. The packet ring 2-A includes five node devices 1-a to 1-e and a coupling node device 6-a, whilst the packet ring 2-B includes five node devices 1-f to 1-j and a coupling node device 6-b. The node devices 1-a to 1-e and the coupling node device 6-a are interconnected by a clockwise ringlet 4-0, whilst the node devices 1-f to 1-j and the coupling node device 6-b are interconnected by a clockwise ringlet 4-1.

The coupling node devices 6-a and 6-b are interconnected by a bidirectional inter-ring link 5. The node devices 1-a to 1-j are provided with bidirectional tributary ports 3-a to 3-j, respectively. It is via these tributary ports that a packet is added (i.e. transmitted) within the ring or dropped (i.e. received) from outside the ring.

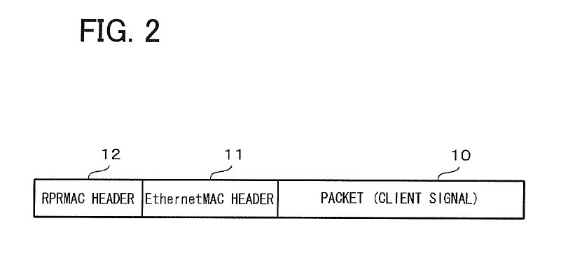

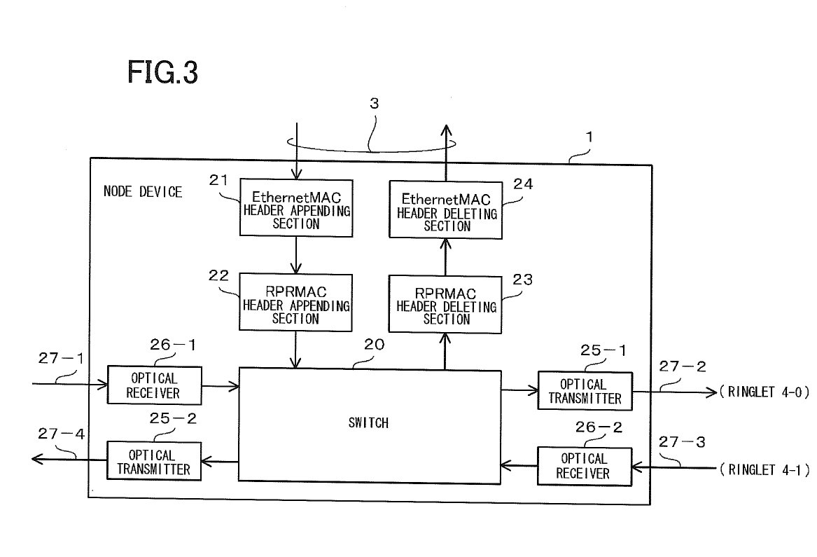

FIG. 3 shows an example of the constitution of the node devices 1-a to 1-j. Initially, the operation of adding a packet is described. A client signal, such as Ethernet packet or IP packet, delivered to the tributary port 3, is converted into an RPR packet, shown in FIG. 2, by an Ethernet MAC header appending section 21 and an RPR MAC header appending section 22.

It should be noted that an RPRMAC header 12 is an intra-ring header and an EthernetMAC header 11 is an inter-ring header. The inter-ring service class is termed “inter-ring MAC service class” and the intra-ring service class is termed “intra-ring MAC service class”.

In FIG. 2, the EthernetMAC header 11 is appended by the Ethernet MAC header appending section 21, and is used as an inter-ring MAC header. The RPRMAC header 12 is appended by the RPR MAC header appending section 22 and is used as an intra-ring MAC header. A packet 10 is a packet of a client signal.

In the EthernetMAC header 11, there are included a transmission source Ethernet MAC address, a destination Ethernet MAC address and the information on the classes of service, referred to below as EthernetCos. In the RPRMAC header 12, there are included a transmission source RPRMAC address, a destination RPRMAC address and the information on the class(es) of service, referred to below as RPRSC.

Returning to FIG. 3, it is determined by a switch 20 to which of the ringlet 4-0 and the ringlet 4-1 is to be transmitted the RPR packet output from the RPR MAC header appending section 22, depending on the destination RPRMAC address. In general, the RPR packet is transmitted to a ringlet having a smaller distance to the destination.

In case the RPR packet is transmitted to the ringlet 4-0, it is converted by an optical transmitter 25-1 into an optical signal, which is transmitted on an optical fiber 27-2. In case the RPR packet is transmitted to the ringlet 4-1, it is converted by an optical transmitter 25-2 into an optical signal, which is transmitted to an optical fiber 27-4.

The operation of dropping a packet is now described. The RPR packet, received from the ringlet 4-0 of the node device 1, is delivered from an optical fiber 27-1 to an optical receiver 26-1 where it is converted into an electrical signal which is delivered to the switch 20. In similar manner, the RPR packet, received from the ringlet 4-1, is delivered from an optical fiber 27-3 to an optical receiver 26-2, where it is converted into an electrical signal which is delivered to the switch 20. If it is found in the switch 20 that the destination RPRMAC address of the RPR packet is an address of this node device, the RPRMAC header is deleted from the packet by an RPRMAC header deleting section 23, and further an EthernetMAC header is deleted from the packet by an EthernetMAC header deleting section 24. The resulting signal is output as a client signal via a tributary port 3.

A RPR packet not dropped by the switch 20, that is, the RPR packet in which the destination RPRMAC address is an address of a node device different than this node device, is packet-multiplexed with a client signal added in this node device, and is again transmitted to the ringlet 4-0 or 4-1.

That is, the RPR packet, received from the ringlet 4-0, is again transmitted from the optical transmitter 25-1 to the ringlet 4-0 (optical fiber 27-2). The RPR packet, received from the ringlet 4-1, is again transmitted from the optical transmitter 25-2 to the ringlet 4-1 (optical fiber 27-4).

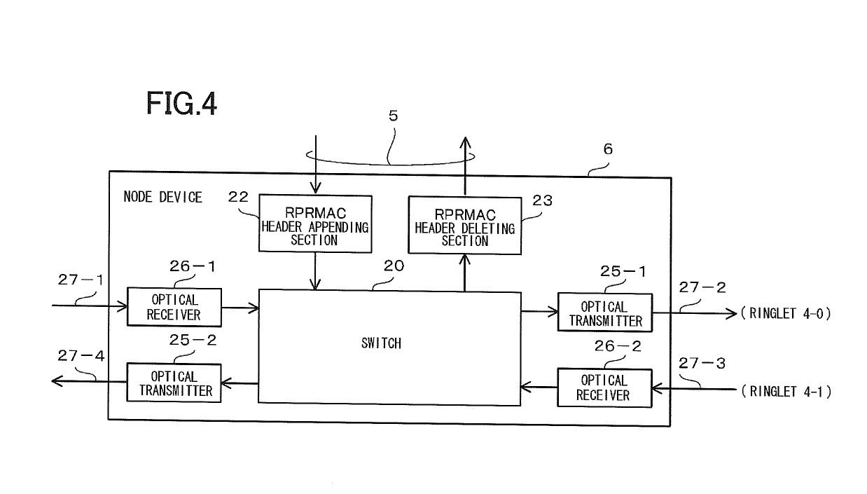

FIG. 4 shows an example of the constitution of the coupling node device 6. This coupling node device is generally analogous, in constitution and operation, with the node device 1. It is however different in that it lacks in the Ethernet MAC header appending section 21 and in the EthernetMAC header deleting section 24, and in that it is connected not to the tributary port 3 but to the inter-ring link 5.

If, in the switch 20 of the coupling node device 6, an RPRMAC address is not an address of the coupling node device 6 or the node device 1, belonging to the same packet ring 2, the RPR packet is dropped. From the so dropped packet, the RPRMAC header is deleted in the RPRMAC header deleting section 23, and the resulting packet is transmitted as an EthernetMAC packet to the inter-ring link 5.

To the EthernetMAC packet, received from the inter-ring link 5, an RPRMAC header is appended by the RPR MAC header appending section 22, and the resulting packet is delivered to the switch 20. The ensuing operation is analogous with the operation of the node device 1 already explained.

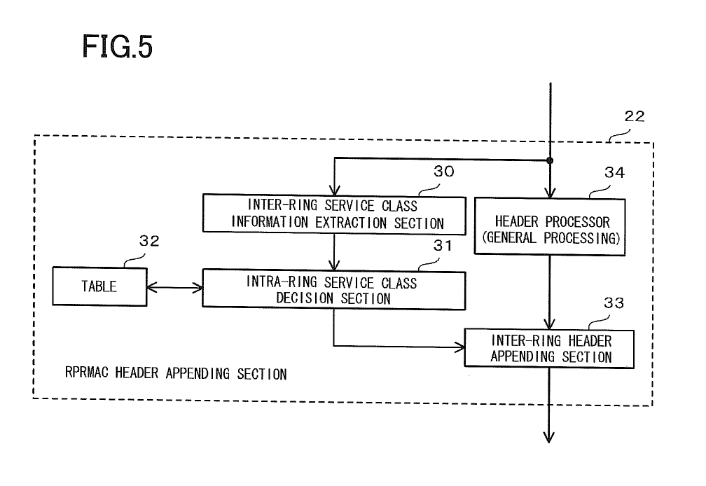

Strongly characteristic of the present exemplary embodiment is the RPR MAC header appending section 22, the constitution of which is shown in FIG. 5. In this figure, the RPR MAC header appending section 22 includes an inter-ring service class information extraction section 30, an intra-ring service class decision section 31, and an intra-ring header appending section 33. The inter-ring service class information extraction section 30 extracts the information on the service class of the inter-ring MAC included in the EthernetMAC header 11 appended to the packet 10 that has arrived from other packet ring. The intra-ring service class decision section decides on the service class of the intra-ring MAC to be set in the incoming packet 10, based on the service class information of the inter-ring MAC extracted by this inter-ring service class information extraction section 30, by referencing a table 32. The intra-ring header appending section 33 appends, to the incoming packet 10, a RPRMAC header 12 inclusive of information on the intra-ring MAC service class as determined by the intra-ring service class decision section 31. Meanwhile, a header processor (unit) 34 is a functional block for performing routine (general) header processing not directly relevant to the present invention and hence the detailed description therefor is dispensed with.

The operation of the present exemplary embodiment is now described. Referring to FIG. 1, the case of transferring a packet flow of voice communication delivered to a tributary port 3-a of the node device 1-a to a tributary port 3-j of the node device 1-j is now scrutinized. The node device 1-a appends an EthernetMAC header 11 and an RPRMAC header 12 to packets 10 contained in this packet flow in their entirety.

An address of the tributary port 3-a and an address of the tributary port 3-j are set in the transmission source EthernetMAC address and in the destination EthernetMAC address of the EthernetMAC header 11, respectively.

In the transmission source RPRMAC address and in the destination RPRMAC address of the RPRMAC header 12, there are set an address of the node device 1-a and an address of the coupling node device 6-a, respectively.

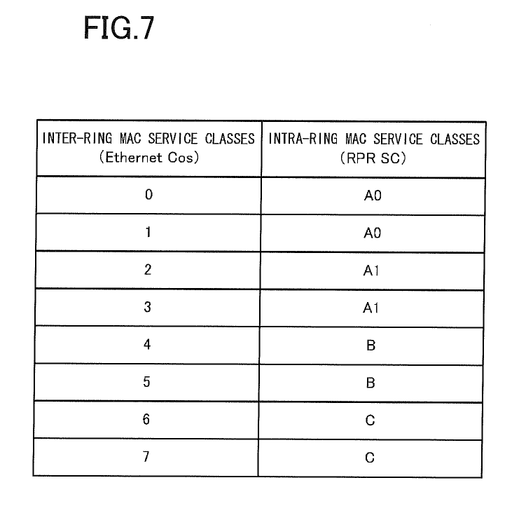

This packet flow is a voice signal and hence needs to be handled with a high class of service. So, “0” is set in EthernetCoS. The RPRSC is determined by having reference to the table of correspondence of FIG. 7, included in the table 32, based on the EthernetCoS of the EthernetMAC header 11. Since here the EthernetCoS is “0”, the corresponding value “A0” is set in the RPRSC.

The packet 10 is transferred to the ringlet 4-1 and transferred via the node devices 1-d and 1-e so as to be dropped by the coupling node device 6-a. Since RPRSC is “A0”, it is transferred in priority to other packets having a lower RPRSC class of e.g., “B” or “C”, even when there is a congested state on the way.

The coupling node device 6-a deletes the RPRMAC header 12 from the dropped packet and transmits the resulting packet to the coupling node device 6-b. In this coupling node device 6-b, an RPRMAC header 12 is again appended to the packet. At this time, an address of the coupling node device 6-b is set in the transmission source RPRMAC address, and an address of the node device 1-j is set in the destination RPRMAC address. The RPRSC (intra-ring MAC service class) is again determined, based on the EthernetCoS (inter-ring MAC service class) of the EthernetMAC header 11, by having reference to the table of correspondence of FIG. 7, included in the table 32.

Since here the EthernetCoS is “0”, the value “A0”, corresponding thereto, is set in the RPRSC. The packet is transferred to the ringlet 4-1 and thence through the node devices 1-h and 1-i so as to be dropped by the node device 1-j. Since here the RPRSC is again “A0”, the packet is transferred in priority to other packets having the RPRSC of “B” or “C”, even when there is a congested state on the way. The node device 1-j deletes the RPRMAC header 12 and the EthernetMAC header 11 from the dropped packet and outputs the resulting packet to the tributary port 3-j.

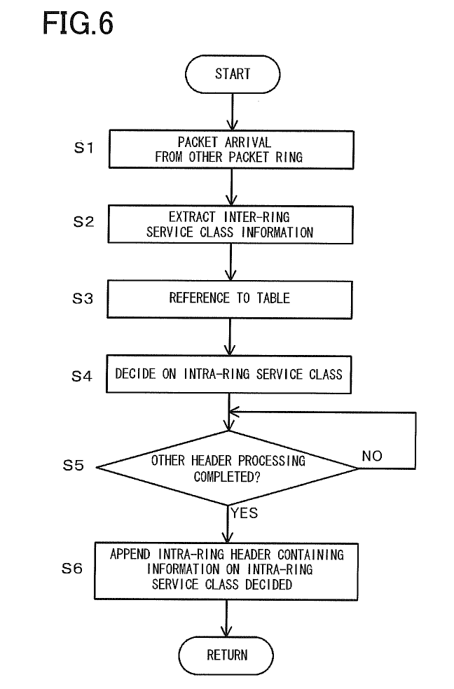

The above operation is shown in a flowchart of FIG. 6 from the perspective of the operation of the RPR MAC header appending section 22. When a packet 10 has arrived from any other packet ring at the RPR MAC header appending section 22 (S1), the inter-ring service class information extraction section 30 extracts the information on the inter-ring MAC service class from the EthernetMAC header 11 of the packet 10 (S2). The intra-ring service class decision section 31 then references the table 32 (S3) to decide on the intra-ring MAC service class (S4). The correspondence table in the table 32 is shown in FIG. 7. When the header processor 34 has finished the other routine (general) header processing (S5), the intra-ring header appending section 33 appends to the packet 10 the RPRMAC header 12 that includes the information on the service class of the intra-ring MAC thus determined (S6).

### Second Exemplary Embodiment

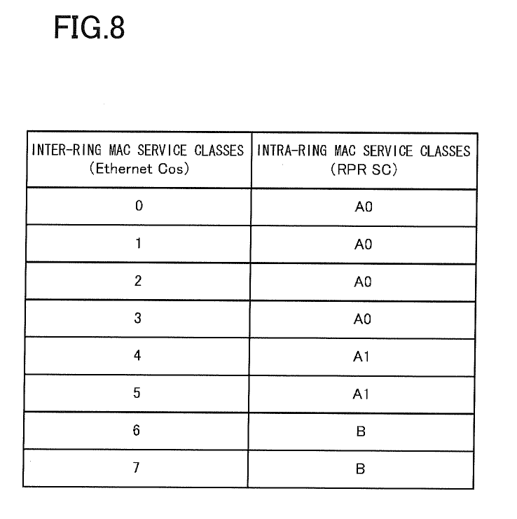

The second exemplary embodiment of the present invention is directed to an optical communication network which is identified in constitution with the above-described first exemplary embodiment. However, the present second exemplary embodiment differs from the first exemplary embodiment as to the method in which the intra-ring service class decision section 31 decides on RPRSC in the RPR MAC header appending section 22 of the coupling node device 6-a or the coupling node device 6-b. Take the case in which the packet flow of the voice communication, delivered to the tributary port 3-a of the node device 1-a, is to be transferred to the tributary port 3-j of the node device 1-j, as in the first exemplary embodiment. In this case, when the RPRMAC header 12 is appended to the packet in the RPR MAC header appending section 22 of the coupling node device 6-b, the RPRSC is decided on, based on the correspondence table in the table 32 shown in FIG. 8. It is seen that, in the correspondence table of FIG. 8, the values of the classes of the RPRSC, correlated with the same values of the EthernetCoS, are higher by one than those in the correspondence table of FIG. 7 for certain EthernetCos classes (2-7).

Hence, for instance, class Al is applied in the packet ring 2-B as the RPRSC to a packet flow to which class B was applied in the packet ring 2-A.

In general, the ratio of packets discarded becomes higher the more is the number of packet rings traversed by the packets. For example, a packet transferred with class B from the node device 1-a to the node device 1-j is more likely to be discarded than another packet transferred with the same class B from the node i-h to the node 1-j. This problem may be eliminated or alleviated with the present exemplary embodiment in which the service class higher than that applied in the first packet ring is applied in the second packet ring.

### Third Exemplary Embodiment

A third exemplary embodiment of the present invention is directed to an optical communication network which is identified in constitution with the above-described first and second exemplary embodiments. However, the present third embodiment differs from the first and second exemplary embodiments as to the method in which RPRSC is determined in the coupling node device 6-a or 6-b. Take the case in which a packet flow of the voice communication, delivered to the tributary port 3-a of the node device 1-a, is to be transferred to the tributary port 3-j of the node device 1-j, as in the first and second exemplary embodiments.

If, in appending the RPRMAC header 12 in the coupling node device 6-b, there is no congestion in the packet ring 2-B, the RPRSC is determined based on the correspondence table of FIG. 7 present in the table 32. In contrast, should there be a state of congestion within the packet ring 2-B, the RPRSC is determined based on the correspondence table of FIG. 8 in the table 32. In the Resilient Packet Ring RPR, should a state of congestion be detected by a node device within a packet ring, such state is notified to the remaining node devices using a fairness notification frame. This fairness notification frame may then be monitored and analyzed to detect the possible presence of the congested state within a packet ring.

This congestion detection unit may be provided in, for example, the RPRMAC header deleting section 23, and the fairness notification frame therein may be monitored when deleting the RPRMC header. The result of the detection of congestion is notified to the intra-ring service class decision section 31 within the RPR MAC header appending section 22.

The bandwidth utilization efficiency may be improved by deciding on the service class applied by the intra-ring service class decision section 31, taking the congested state in the packet ring into account.

In the second exemplary embodiment, the problem that the ratio of packets discarded becomes higher with increase in the number of the rings traversed by the packet(s) may be eliminated or alleviated by applying the service class higher in rank for the second and the following rings than the first packet ring. However, this advantage is compromised because the probability of the high service classes being applied increases with the second and the following packet rings, thus correspondingly decreasing the bandwidth utilization efficiency.

With the present exemplary embodiment, the higher service classes are applied only in case there is congested state in the packet ring, in accordance with the table of correspondence of FIG. 8, thereby improving the bandwidth utilization efficiency in case there is no congested state.

### Fourth Exemplary Embodiment

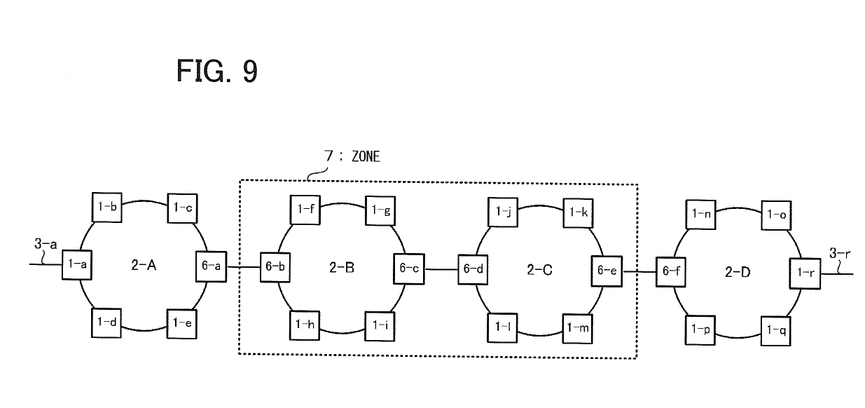

A fourth exemplary embodiment of the present invention is now described with reference to FIG. 9. An optical communication network, shown in FIG. 9, is composed of four packet rings 2-A, 2-B, 2-C and 2-D. A zone containing the packet rings 2-B and 2-C is labeled a zone 7.

Take the case in which a packet flow, delivered to a tributary port 3-a of a node device 1-a, is to be transferred to a tributary port 3-r of a node device 1-r. In the node device 1-a, the EthernetMAC header 11 and the RPRMAC header 12 are appended to this packet flow. It is assumed that the EthernetCoS at this time is “4”, with the RPRSC being “B” in accordance with the table of correspondence of FIG. 7 in the table 32.

As in the first to third exemplary embodiments, the packet flow is transferred to the coupling node device 6-a, where the RPRMAC header 12 is deleted. The packet flow is further transferred to the coupling node device 6-b.

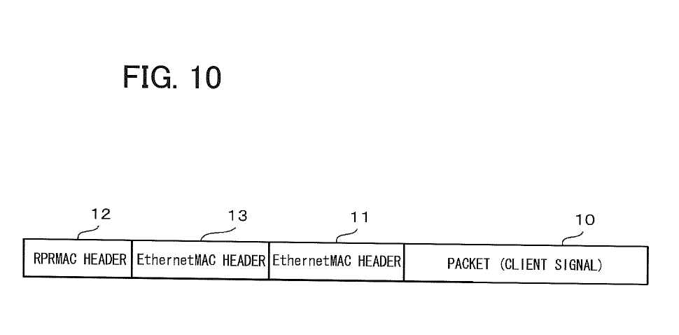

Characteristic of the present exemplary embodiment is the fact that a service class applied in the zone 7 differs from that applied outside the zone 7. To this end, a second EthernetMAC header 13 is appended to a packet present within the zone 7, and the EthernetCoS thereof is set independently of that of the pre-existing first EthernetMAC header. The packet constitution in this case is shown in FIG. 10.

It is assumed that the value “0” is desirably applied at all times as the EthernetCoS within the zone 7. In such case, the second EthernetMAC header 13 is appended to each packet, and the EthernetCoS thereof is set to “0”, in the coupling node device 6-b which is an entrance to the zone 7. The RPRMAC header 12 is further appended to this packet. In order to decide on the RPRSC, reference is made to the EthernetCoS of the second EthernetMAC header 13. The RPRSC is set to “A0” in accordance with the table of correspondence of FIG. 7.

In a coupling node device 6-c of the packet ring 2-B, the RPRMAC header 12 is deleted. When the RPRMAC header is appended in a coupling node device 6-d of the packet ring 2-c, reference is again made to the EthernetCoS of the second EthernetMAC header 13. The RPRSC is set to “A0” in accordance with the table of correspondence of FIG. 7. When the packet flow is transferred to a coupling node device 6-e, which is an exit of the zone 7, the RPRMAC header 12 is deleted, at the same time as the second EthernetMAC header 13 is also deleted.

When the RPRMAC header is appended in a coupling node device 6-f of the packet ring 2-D, reference is made to the EthernetCoS of the first EthernetMAC header 11. Now, the RPRSC of “B” is set which is in meeting with the value “4” of the EthernetCoS in the table of correspondence of FIG. 7.

By stacking a plurality of EthernetMAC headers, and by providing a unit for designating a zone (or zones) in which the so stacked EthernetMAC headers remain valid, the hierarchical service class setting, such as applying a specified service class only in a specified zone, becomes possible. Such unit may be provided in, for example, the Ethernet MAC header appending section 21, and has the function of having a user set the service class, and of accepting the information on the zone designation.

In the first to fourth exemplary embodiments, the sole inter-ring link 5 is used to interconnect the packet rings. The present invention may, however, be applied to any (optical) communication network provided with a plurality of inter-ring links between neighboring packet rings.

Also, in the first to fourth exemplary embodiments, the neighboring packet rings are directly interconnected by the inter-ring link 5. However, such a constitution in which there is an Ethernet network between neighboring packet rings may operate in similar manner.

### Exemplary Embodiments of Program

An exemplary embodiment of a program which may be installed on a (typically general-purpose) information processing apparatus to permit the information processing apparatus to carry out the functions corresponding to the functions of the node devices 1-a to 1-j or the coupling node devices 6-a and 6-b, is now described.

A program, that is computer readable, of the present exemplary embodiment may be recorded on a recording medium, so that the general-purpose information processing apparatus may use this recording medium to install the program of the present exemplary embodiment. Or, the program of the present exemplary embodiment may directly be installed on the (general-purpose) information processing apparatus from a server holding the program of the present exemplary embodiment over a network.

By so doing, the functions equivalent to the functions of the node devices 1-a to 1-j or the coupling node devices 6-a and 6-b of the present exemplary embodiment may be implemented using, preferably, the general-purpose information processing apparatus.

It should be noticed that the program of the present exemplary embodiment encompasses not only the program that may directly be run by a general-purpose information processing apparatus, but the program that may be run when installed on e.g. a hard disc or the program that has been compressed or encrypted.

### INDUSTRIAL UTILIZABILITY

The present invention may be exploited for any packet transfer through a plurality of packet rings, in which packets may be transported as the preset service quality is maintained even after the packets have traversed a plurality of packet rings.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A communication system comprising:
a plurality of packet rings, each composed of a plurality of node devices, said node devices each transmitting and receiving a packet and being interconnected in a ring; two of said packet rings being interconnected via a pair of node devices each in each of the packet rings;
said communication system further comprising:
a table having recorded therein the correspondence between inter-ring service classes set between said packet rings and intra-ring service classes set in each packet ring;
wherein said packet transferred in said packet ring includes information on said intra-ring service classes, as intra-ring header information, and information on said inter-ring service class, as inter-ring header information, said inter-ring service class(es) being correlated with said intra-ring service class(es), and being determined based on said table; said intra-ring header information being deleted when said packet is transferred from one of said packet rings to another.

2. The communication system according to claim 1, further comprising:
an extracting unit that extracts information on said inter-ring service class contained in said inter-ring header information appended to said packet incoming from another packet ring;
a determining unit that determines said intra-ring service class to be set on said incoming packet, by having reference to said table, based on said information on said inter-ring service class extracted by said extraction unit; and
an appending unit that appends to said incoming packet the intra-ring header information containing the information on said intra-ring service class as determined by said determining unit.

3. The communication system according to claim 1 wherein said table is configured so that the setting of said intra-ring service class will be higher in a packet ring corresponding to a packet transfer destination than in a packet ring corresponding to a packet transfer source belonging to the same inter-ring service class as that of said packet ring corresponding to the packet transfer destination.

4. The communication system according to claim 1 further comprising:
a congestion detection unit that detects whether or not there is congestion in said packet ring which is a transfer destination; and
a selecting unit that selects a table configured so that a setting of service class in said packet ring corresponding to the packet transfer destination will be higher than a setting of service class in said packet ring corresponding to the packet transfer source, in case said congestion detection unit has detected the congestion; or a table configured so that table contents will be the same in said packet ring corresponding to the packet transfer source and in said packet ring corresponding to the packet transfer destination in case said congestion detection unit has not detected the congestion.

5. The communication system according to claim 1 further comprising:
an appending unit that appends to said packet, transferred between said packet rings, a plurality of said inter-ring header information, by specifying a zone in which said header information is valid.

6. The communication system according to claim 1, further comprising:
extracting means for extracting information on said inter-ring service class contained in said inter-ring header information appended to said packet incoming from another packet ring;
determining means for determining said intra-ring service class to be set on said incoming packet, by having reference to said table, based on said information on said inter-ring service class extracted by said extraction means; and
appending means for appending to said incoming packet the intra-ring header information containing the information on said intra-ring service class as determined by said determining means.

7. A node device for a communication system that includes a plurality of packet rings each composed of a plurality of said node devices, said node devices each transmitting and receiving a packet and being interconnected in a ring; two of said packet rings being interconnected between a pair of devices each in each of the packet rings;
said node device comprising:
a table having recorded therein correspondence between inter-ring service classes as set between said packet rings and intra-ring service classes as set in said packet ring;
wherein said packet transferred in said packet ring includes information on said intra-ring service classes, as intra-ring header information, and information on said inter-ring service classes, as the inter-ring header information; said inter-ring service classes being correlated with said intra-ring service classes, and being determined based on said table; said intra-ring header information being deleted when said packet is transferred from one of said packet rings to another.

8. The node device according to claim 7, further comprising:
an extracting unit that extracts information on said inter-ring service class contained in said inter-ring header information appended to said packet incoming from another packet ring;
a determining unit that determines said intra-ring service class to be set on said incoming packet, based on said information on said inter-ring service class extracted by said extraction unit, by having reference to said table; and
an appending unit that appends to said incoming packet the intra-ring header information containing the information on said intra-ring service class as determined by said determining unit.

9. The node device according to claim 7 wherein said table is configured so that said intra-ring service class will be set depending on whether a packet ring concerned is source or destination of the packet transfer.

10. The node device according to claim 7, further comprising:
means for extracting information on said inter-ring service class contained in said inter-ring header information appended to said packet incoming from another packet ring;
means for determining said intra-ring service class to be set on said incoming packet, based on said information on said inter-ring service class extracted by said extraction means, by having reference to said table; and
means for appending to said incoming packet the intra-ring header information containing the information on said intra-ring service class as determined by said determining means.

11. The node device according to claim 7 wherein said table is configured so that the setting of said intra-ring service class will be higher at a packet ring corresponding to a packet transfer destination than at a packet ring corresponding to a packet transfer source belonging to the same inter-ring service class as that of said packet ring corresponding to the packet transfer destination.

12. The node device according to claim 7 further comprising:
a congestion detection unit that detects whether or not there is a state of congestion in said packet ring which is a destination of transfer; and
a selecting unit that selects a table configured so that the setting of service classes in said packet ring corresponding to the destination of packet transfer will be higher than the setting of service classes in said packet ring corresponding to the source of packet transfer in case said congestion detection unit has detected the state of congestion, or a table configured so that table contents will be the same in said packet ring corresponding to the source of packet transfer and in said packet ring corresponding to the destination of packet transfer in case said congestion detection unit has not detected the state of congestion.

13. The node device according to claim 7, further comprising:
an appending unit that appends to said packet, transferred between said packet rings, a plurality of said inter-ring header information, by specifying a zone in which said plural header information is valid.

14. A communication network including the communication system according to claim 1.

15. A computer readable program to be installed in an information processing apparatus, said program causing said information processing apparatus to implement the functions equivalent to the functions of the node device according to claim 7.

16. A method for setting service classes to be carried out by a node device, said method being applied to a communication system, said communication system including a plurality of packet rings each composed of a plurality of said node devices, said node devices each transmitting and receiving a packet and being interconnected in a ring via a first bidirectional transmission route; two of said packet rings being interconnected by one or more second bidirectional transmission routes; each of said second bidirectional transmission routes being connected to any one of said node devices of said two packet rings; wherein the method comprises:
providing a packet to be transferred in said packet ring including information on said intra-ring service class, set in said packet ring, as intra-ring header information, and information on said inter-ring service class, set between the packet rings, as inter-ring header information; said inter-ring service class(es) being correlated with said intra-ring service class(es), and being determined based on a table that indicates the correspondence between said inter-ring service class(es) as set between said packet rings and said intra-ring service class(es); and
detecting said intra-ring header information when said packet is transferred from one of said packet rings to another.

17. The method according to claim 16, wherein said method further comprises:
extracting information on said inter-ring service class contained in said inter-ring header information appended to said packet incoming from another packet ring;
determining said intra-ring service class to be set on said incoming packet, based on said information on said inter-ring service class extracted by said extraction step, by having reference to said table; and
appending to said packet incoming from said packet ring the intra-ring header information containing the information on said intra-ring service class as determined by said determining step.

18. The method according to claim 16 wherein said table is configured so that said intra-ring service class correlated with the same inter-ring service class will be higher in a packet ring corresponding to a packet transfer destination than in a packet ring corresponding to a packet transfer source.

19. The method for setting service classes according to claim 16, further comprising:
detecting whether or not there is congestion in said packet ring which is a destination of transfer; wherein
in case said congestion has been detected, a table, configured so that a setting of service class in said packet ring corresponding to the destination of packet transfer will be higher than a setting of service class in said packet ring corresponding to the source of packet transfer, is used; and
in case said congestion has not been detected, a table, configured so that table contents will be the same in said packet ring corresponding to the source of packet transfer and in said packet ring corresponding to the destination of packet transfer, is used.

20. The service class setting method for setting service classes according to claim 16 wherein
a plurality of said inter-ring header information are appended to said packet, transferred between said packet rings, by specifying a zone in which said plural header information is valid.

21. A computer readable program to be installed in an information processing apparatus, said program causing said information processing apparatus to execute a sequence of operations equivalent to the sequence of operations of the method for setting the service classes according to claim 16.
